(19) United States
(12) Patent Application Publication
(10) Pub. No.: US 2025/0152977 A1
(43) Pub. Date: May 15, 2025

(54) SELF-CONTAINED BREATHING APPARATUS, COMPONENT THEREOF, AND BATTERY COMPARTMENT THEREFOR

(71) Applicant: Honeywell Safety Products USA, Inc., Charlotte, NC (US)

(72) Inventors: Siwei WANG, Charlotte, NC (US); Xiaojin HAN, Charlotte, NC (US); Hongbing XIANG, Charlotte, NC (US); Sheng ZHOU, Charlotte, NC (US)

(21) Appl. No.: 18/925,787

(22) Filed: Oct. 24, 2024

(30) Foreign Application Priority Data
Nov. 9, 2023 (CN) 202311492372.6

(51) Int. Cl. A62B 9/00

(52) U.S. Cl. CPC A62B 9/006

(57) ABSTRACT

A digital display device is provided. For example, a digital display device may include a rigid housing, a compressible layer over at least a portion of the rigid housing, and a rigid cover. The rigid housing defines an internal chamber and an opening to a battery compartment. The battery compartment is adapted to receive a battery in a position with a longitudinal axis of the battery being substantially parallel to the opening. The compressible layer defines an opening that is coterminous with the opening to the battery compartment. The rigid cover is selectively attachable to the rigid housing such that, when the rigid cover is selectively attached to the rigid housing, at least a portion of the compressible layer is sandwiched between the rigid cover and the rigid housing and at least a portion of the rigid cover at least partly compresses a corresponding portion of the compressible layer.

### CROSS-REFERENCE TO RELATED APPLICATIONS

This application claims priority pursuant to 35 U.S.C. § 119(a) to Chinese Application No. 202311492372.6, filed Nov. 9, 2023, which application is incorporated herein by reference in its entirety.

### FIELD OF THE INVENTION

Embodiments of the present disclosure generally relate to self-contained breathing apparatuses, and, more particularly, to battery compartments for self-contained breathing apparatuses.

### BACKGROUND

A self-contained breathing apparatus (“SCBA”) is a device used to provide air to the user when the air of the environment is dangerous for the user to breathe. Such environments may be deemed “immediately dangerous to life and health” or “IDLH” environments. SCBAs are often used by firefighters or other first responders when in dangerous environments. Applicant has identified a number of deficiencies and problems associated with conventional SCBAs. Through applied effort, ingenuity, and innovation, many of these identified problems have been solved by developing solutions that are included in embodiments of the present invention, many examples of which are described in detail herein.

### BRIEF SUMMARY

Various embodiments described herein relate to SCBAs, components for SCBAs, and battery compartments for SCBAs and components of SCBAs.

In accordance with various embodiments of the present disclosure, a digital display device is provided. In some embodiments, the digital display device comprises a rigid housing, a compressible layer over at least a portion of the rigid housing, and a rigid cover. The rigid housing defines an internal chamber and an opening to a battery compartment. The battery compartment is separated from the internal chamber and adapted to receive a battery in a position with a longitudinal axis of the battery being substantially parallel to the opening to the battery compartment. The compressible layer defines an opening that is coterminous with the opening to the battery compartment. The rigid cover has an interior side and an opposing exterior side and is selectively attachable to the rigid housing such that, when the rigid cover is selectively attached to the rigid housing, at least a portion of the compressible layer is sandwiched between the rigid cover and the rigid housing and at least a portion of the rigid cover at least partly compresses a corresponding portion of the compressible layer.

In some embodiments, the rigid cover comprises at least two opposing jaws projecting from the interior side and adapted to hold the battery therebetween in a position such that the longitudinal axis of the battery is substantially parallel to the interior side for insertion into the battery compartment when the rigid cover is selectively attached to the rigid housing. In some embodiments, the at least two opposing jaws each have curved medial edges adapted to contact an exterior wall of the battery to hold the battery.

In some embodiments, the at least two opposing jaws comprise two jaws on a first side of a midline of the rigid cover and one jaw on a second, opposing side of the midline of the rigid cover.

In some embodiments, the rigid cover defines a fastener hole for inserting a fastener to secure the rigid cover to the rigid housing and the rigid cover further comprises a ridge protruding from the interior side and surrounding the fastener hole. When the rigid cover is selectively attached to the rigid housing, the ridge at least partly compresses a corresponding portion of the compressible layer.

In some embodiments, the fastener comprises a screw.

In some embodiments, the compressible layer comprises an overmolded layer on the rigid housing.

In some embodiments, the rigid cover comprises a pull ring pivotably attached to the exterior side of the rigid cover.

In some embodiments, the digital display device comprises a display device of a self-contained breathing apparatus for displaying an air pressure reading.

In accordance with various embodiments of the present disclosure, a self-contained breathing apparatus is provided. In some embodiments, the self-contained breathing apparatus comprises an air tank, a face mask connected via tubing to the air tank, and a digital display device for displaying an air pressure reading of the air tank. The digital display device comprises a rigid housing, a compressible layer over at least a portion of the rigid housing, and a rigid cover. The rigid housing defines an internal chamber and an opening to a battery compartment. The battery compartment is separated from the internal chamber and adapted to receive a battery in a position with a longitudinal axis of the battery being substantially parallel to the opening to the battery compartment. The compressible layer defines an opening that is coterminous with the opening to the battery compartment. The rigid cover has an interior side and an opposing exterior side and is selectively attachable to the rigid housing such that, when the rigid cover is selectively attached to the rigid housing, at least a portion of the compressible layer is sandwiched between the rigid cover and the rigid housing and at least a portion of the rigid cover at least partly compresses a corresponding portion of the compressible layer.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example SCBA in accordance with example embodiments of the present disclosure;

FIGS. 2A and 2B illustrate an example digital display unit of the example SCBA of FIG. 1, in accordance with example embodiments of the present disclosure;

FIG. 3 is a partially exploded view of the example digital display of FIGS. 2A and 2B, in accordance with example embodiments of the present disclosure;

FIGS. 4A and 4B illustrate an example battery compartment cover of the example digital display of FIGS. 2A and 2B, in accordance with example embodiments of the present disclosure; and,

FIG. 5 is a sectional view of the example digital display of FIGS. 2A and 2B, in accordance with example embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” “bottom,” “left,” “right,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The phrases “in one example,” “according to one example,” “in some examples,” and the like generally mean that the particular feature, structure, or characteristic following the phrase may be included in at least one example of the present disclosure and may be included in more than one example of the present disclosure (importantly, such phrases do not necessarily refer to the same example).

If the specification states a component or feature “may,” “can,” “could,” “should,” “would,” “preferably,” “possibly,” “typically,” “optionally,” “for example,” “as an example,” “in some examples,” “often,” or “might” (or other such language) be included or have a characteristic, that specific component or feature is not required to be included or to have the characteristic. Such component or feature may be optionally included in some examples, or it may be excluded.

The word “example” or “exemplary” is used herein to mean “serving as an example, instance, or illustration.” Any implementation described herein as “example” or “exemplary” is not necessarily to be construed as preferred or advantageous over other implementations.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

The term “component” may refer to an article, a device, or an apparatus that may comprise one or more surfaces, portions, layers and/or elements. For example, an example component may comprise one or more substrates that may provide underlying layer(s) for the component and may comprise one or more elements that may form part of and/or are disposed on top of the substrate. In the present disclosure, the term “element” may refer to an article, a device, or an apparatus that may provide one or more functionalities.

Some existing SCBAs include digital display units (which may also be termed digital display devices). Such digital display units display the air pressure in the air cylinder of the SCBA and may interface with a heads-up display (HUD) mounted in the face mask of the SCBA to cause the HUD to display information about the air pressure in the air cylinder.

Existing battery compartment designs used in various applications, such as in digital display units for SCBAs, have certain technical problems. For example, in some existing battery compartments, leakage of water and dust into the battery compartment (and then potentially into the interior compartment which houses electronic components (e.g., processor, air pressure sensor, etc.) may occur due to poor sealing.

To address challenges and limitations associated with SCBAs, various examples of the present disclosure may be provided. For example, various examples of the present disclosure may provide example SCBAs, components for SCBAs (such as digital display units), and battery compartments for SCBAs and components of SCBAs. While embodiments of the present disclosure are described herein related to digital display units for SCBAs, embodiments of the present disclosure may be used with other battery-powered components of SCBAs and other non-SCBA battery-powered devices.

Various embodiments of the present disclosure provide an example digital display unit for use in firefighting and other wet and/or harsh (e.g., dirty or contaminated) environments having a sealed battery compartment to reduce the possibility of leakage into the battery compartment and the interior chamber of the device.

In various embodiments, the battery is positioned such that the force of the spring that holds the battery in place (and provides one of the electrical contacts) does not apply an outward force against the battery compartment cover.

In various embodiments, the digital display unit has a compressible layer and the battery compartment cover is attached firmly against the compressible layer to provide a seal that helps prevent the intrusion of water and other contaminants.

In various embodiments, the battery compartment cover has a three-jaw structure to hold the battery in a fixed position for easy insertion and removal.

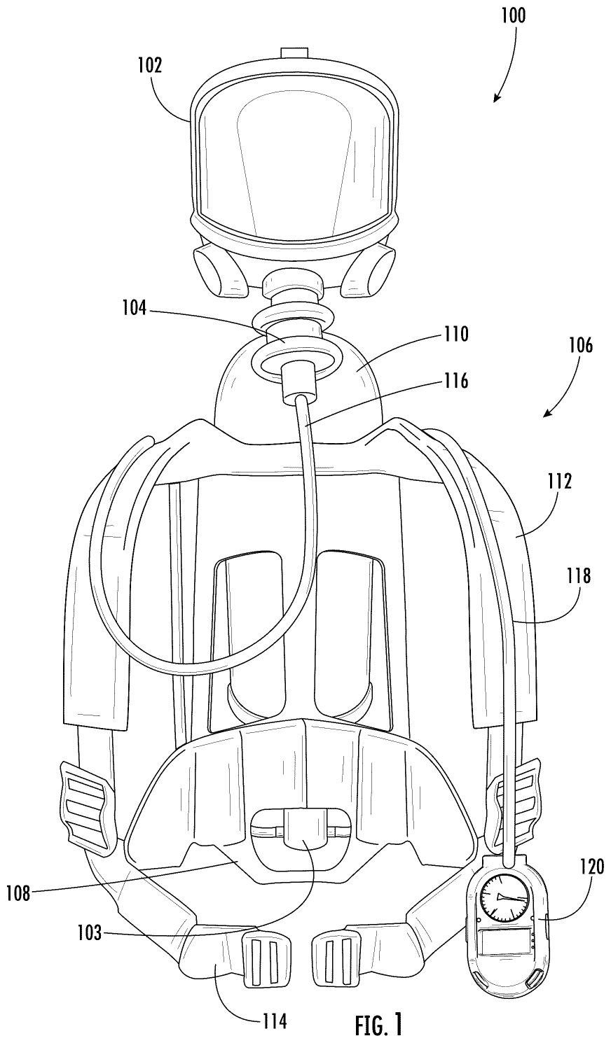

Referring now to FIG. 1, an example SCBA 100 is illustrated in accordance with various embodiments of the present disclosure. As depicted in FIG. 1, in some embodiments the SCBA 100 comprises a face mask 102 (in which a heads-up display (not illustrated) may be mounted) and a harness 106. The harness 106 includes a back frame 108 holding an air cylinder or air tank 110. The harness 106 includes shoulder straps 112 and a waist strap 114 that enable a user to wear the SCBA 100. Breathable air is provided from the air tank 110 via an air hose 116 connected to the air tank 110 via a first stage regulator 103 and connected to the face mask 102 via a second stage regulator 104. Information about the amount of breathable air in the air tank 110 is provided to the user via a discrete analog pressure gauge (not illustrated) or a digital display unit 120 (which may also include an analog pressure gauge) connected to the air tank 110 via an air hose 118. The digital display unit 120 is battery-powered and contains sensitive electronic components and, therefore, should be protected against infiltration of water, dirt, etc.

While the description herein provides an example SCBA 100 and digital display unit 120, it is noted that the scope of the present disclosure is not limited to the description herein. In some examples, an example SCBA 100 and/or digital display unit 120 in accordance with the present disclosure may be in other forms. In some examples, an example SCBA 100 and/or digital display unit 120 may comprise one or more additional and/or alternative elements, and/or may be structured differently than that illustrated in the figures.

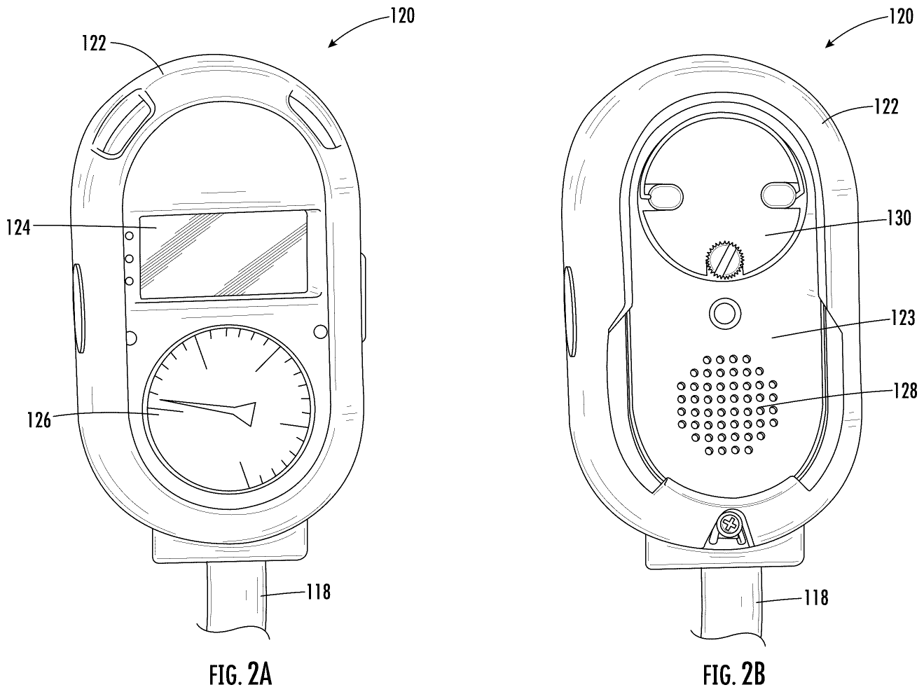

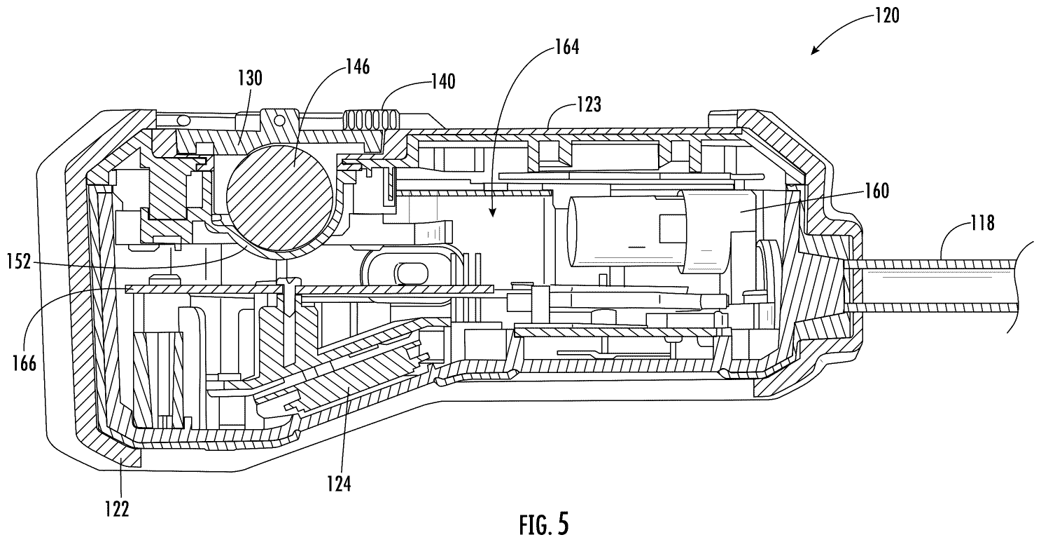

Reference will now be made to FIGS. 2A-2B, which illustrate an example digital display unit 120 of the example SCBA 100 of FIG. 1. The example digital display unit 120 of FIGS. 2A-2B comprises a housing 122 defining an internal chamber (internal chamber 164 is seen in FIG. 5). The housing 122 is constructed of any suitable rigid, durable material or combination of materials, including any suitable plastic such as polycarbonate. A front side of the digital display unit 120 has a digital display 124 (e.g., an LCD display) and an analog pressure gauge 126. In some embodiments, the digital display 124 displays information such as the air pressure within the air tank 110 and other information. A rear side of the digital display unit 120 has a battery compartment cover 130 and a compressible layer 123 over a portion of the housing 122. In FIGS. 2A and 2B, the battery compartment cover 130 is secured in place covering the opening to the battery compartment. In some embodiments, the compressible layer 123 is overmolded on a portion of the housing 122. In some embodiments, the compressible layer 123 comprises rubber, synthetic rubber, or the like. In some embodiments, when the battery compartment cover 130 is selectively attached to the housing 122, at least a portion of the compressible layer 123 is sandwiched between the battery compartment cover 130 and the housing 122 and at least a portion of the battery compartment cover 130 at least partly compresses a corresponding portion of the compressible layer 123 to provide a seal.

In the illustrated example embodiment, a plurality of holes 128 is defined in the rear side of the digital display unit 120 to enable a user or others to hear any sounds (e.g., alarms) emitted by the digital display unit 120, such as may be produced by a Personal Alert Safety System (PASS) function of the digital display unit 120. The digital display unit 120 is connected to an air hose 118 to enable the digital display unit 120 to detect the air pressure within the air tank 110.

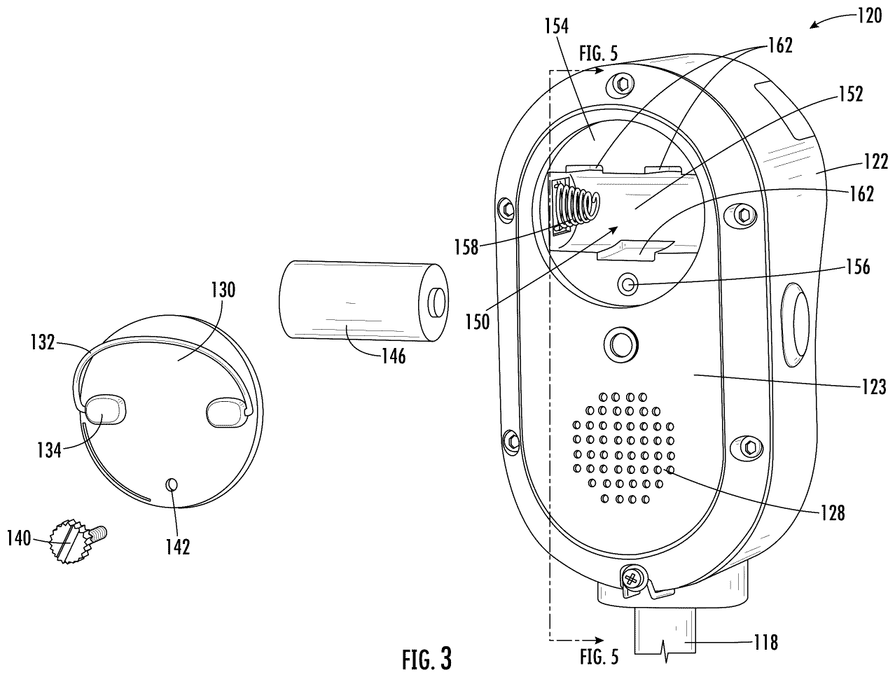

Referring now to FIG. 3, the digital display unit 120 is illustrated with the battery compartment cover 130 and the battery 146 removed. As seen in FIG. 3 with the battery compartment cover 130 removed, a circular depression 154 is defined in the housing 122 (which is also covered by the compressible layer 123) to recessedly receive the circular battery compartment cover 130. In the illustrated example embodiment, the battery compartment 150 is formed by a semicylindrical wall 152 to receive the cylindrical battery 146. As seen in FIG. 3, the arrangement of the battery compartment is such that the battery is received by the battery compartment in a position with the longitudinal axis of the battery being substantially parallel to the opening to the battery compartment. In some existing SCBA digital display units, the battery is received by the battery compartment with the longitudinal axis of the battery being perpendicular to the opening to the battery compartment, in which case the spring pushes the battery against the battery compartment cover, which may adversely affect the seal between the battery compartment cover and the housing.

In the illustrated example embodiment, a spring 158 helps retain the battery 146 in the battery compartment 150 and functions as a negative electrical contact. A positive electrical contact (not illustrated) is positioned on the opposite end of the battery compartment 150. In some embodiments, the spring 158 is constructed of wire having a larger diameter than would typically be used to retain a similar sized battery in order to provide a stronger spring force pushing the battery 146 against the positive electrical contact and thereby providing better retention of the battery 146 in the battery compartment 150. In one example embodiment, the spring 158 is constructed of wire having a diameter of 0.8 millimeters. In various embodiments, where the spring 158 and the positive electrical contact protrude through openings the respective end walls of the battery compartment 150, a sealant (such as an adhesive sealant) is placed around the openings to help prevent any contaminants that enter the battery compartment 150 from also entering the internal chamber 164.

As seen in the illustrated example embodiment, the battery compartment cover 130 comprises a pull ring 132 pivotably attached to the exterior side of the battery compartment cover 130 via two attachment points 134 to enable easy removal of the battery compartment cover 130 for battery replacement. In the illustrated example embodiment, the battery compartment cover 130 defines a fastener hole 142 for inserting a fastener 140 (such as, but not limited to, a screw or bolt) to secure the battery compartment cover 130 to the housing 122. A corresponding fastener hole 156 is defined in the compressible layer 123 and underlying portion of the housing 122 to receive the fastener 140. In embodiments in which the fastener is a male threaded fastener, such as a screw or a bolt, the corresponding fastener hole defined in the housing would be female threaded.

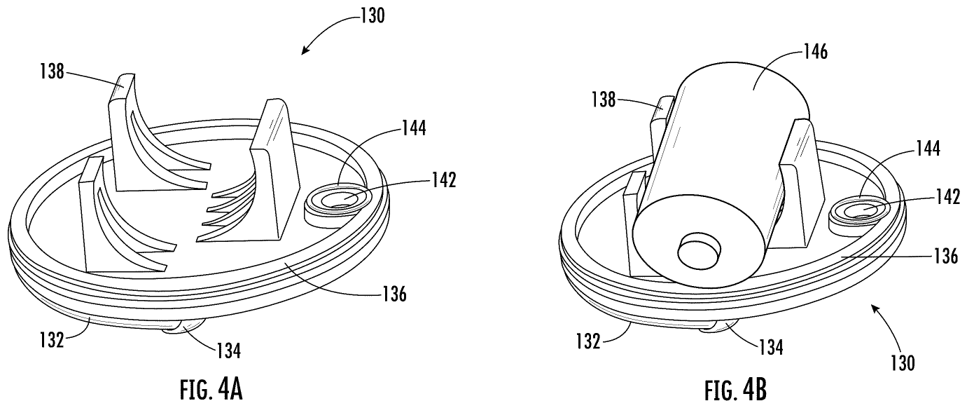

Referring now to FIGS. 4A and 4B, the battery compartment cover 130 is illustrated from the interior side, respectively, without and with the battery 146 being held by the battery compartment cover 130. As seen in FIGS. 4A and 4B, the battery compartment cover 130 comprises three jaws 138 projecting from its interior side for holding the battery 146 therebetween in a position such that the longitudinal axis of the battery is substantially parallel to the interior side of the battery compartment cover 130 for insertion into the battery compartment 150 when the battery compartment cover 130 is selectively attached to the housing 122. In the illustrated embodiment, there are two jaws on a first side of a midline of the battery compartment cover 130 and one jaw on a second, opposing side of the midline of the battery compartment cover 130. As seen in FIG. 3, the opposing long edges of the battery compartment wall 152 define three notches 162—two notches on the top edge and one notch on the bottom edge. These notches 162 align with and receive portions of respective jaws 138 of the battery compartment cover 130 when the battery compartment cover 130 is selectively attached to the housing 122. In this regard, the alignment of the notches and the jaws ensures that the battery compartment cover 130 is properly positioned to place the negative end of the battery 146 against the spring 158 and the positive end of the battery 146 against the positive electrical contact (not illustrated) and to properly align the fastener hole 142 in the battery compartment cover 130 with the corresponding fastener hole 156 in the housing 122.

As seen in FIGS. 4A and 4B, the jaws 138 each have curved medial edges that have substantially the same curvature as the exterior wall of the battery 146 and therefore contact the exterior wall of the battery 146 to retain the battery 146 between the jaws 138. In various embodiments, when a battery is held between the jaws, the distal ends of the jaws (and their curved edges) extend past a median plane that bisects the battery and that is parallel to the battery compartment cover. In this regard, some force is required to move the battery past the distal ends of the jaws while inserting the battery between the jaws or removing the battery from between the jaws, thereby helping to retain the battery between the jaws. In alternative embodiments of the present disclosure, only two opposing jaws may be used or more than three jaws may be used.

As seen in FIGS. 4A and 4B, the battery compartment cover 130 has a ridge 136 protruding from the interior side along its perimeter. Similarly, the battery compartment cover 130 has a ridge 144 protruding from the interior side and surrounding the fastener hole 142. When the battery compartment cover 130 is selectively attached to the housing 122, the perimeter ridge 136 and the fastener hole ridge 144 each at least partly compress corresponding portions of the compressible layer 123 to provide a seal that helps prevent the intrusion of water and other contaminants, respectively, around the edge of the battery compartment cover 130 and through the fastener hole 142.

Referring now to FIG. 5, a cross-section of the digital display until along line FIG. 5-FIG. 5 of FIG. 3 is illustrated. As seen in FIG. 5, many components are located within the internal chamber 164 formed by the housing 122. In the illustrated embodiment, such internal components include a printed circuit board 166 upon which may be mounted, for example, a processor that controls the operation of the digital display unit 120 and a pressure sensor 160 for detecting the air pressure of air in the air hose 118 that is connected to the air tank 110.

In some optional embodiments of the invention, one or more portions of the housing may have two layers that define a space therebetween in which an insulating material (including but not limited to thermal insulation oil or flame-retardant foam) is inserted to protect internal components from heat.

While various embodiments in accordance with the principles disclosed herein have been shown and described above, modifications thereof may be made by one skilled in the art without departing from the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present disclosure. Furthermore, any advantages and features described above may relate to specific embodiments but shall not limit the application of such issued claims to processes and structures accomplishing any or all of the above advantages or having any or all of the above features.

In addition, the section headings used herein are provided for consistency with the suggestions under 37 C.F.R. § 1.77 or to otherwise provide organizational cues. These headings shall not limit or characterize the disclosure set out in any claims that may issue from this disclosure. For instance, a description of a technology in the “Background” is not to be construed as an admission that certain technology is prior art to any disclosure in this disclosure. Neither is the “Summary” to be considered as a limiting characterization of the disclosure set forth in issued claims. Furthermore, any reference in this disclosure to “disclosure” or “embodiment” in the singular should not be used to argue that there is only a single point of novelty in this disclosure. Multiple embodiments of the present disclosure may be set forth according to the limitations of the multiple claims issuing from this disclosure, and such claims accordingly define the disclosure, and their equivalents, which are protected thereby. In all instances, the scope of the claims shall be considered on their own merits in light of this disclosure but should not be constrained by the headings set forth herein.

Also, systems, subsystems, apparatuses, techniques, and methods described and illustrated in the various embodiments as discrete or separate may be combined or integrated with other systems, modules, techniques, or methods without departing from the scope of the present disclosure. Other devices or components shown or discussed as coupled to, or in communication with, each other may be indirectly coupled through some intermediate device or component, whether electrically, mechanically, or otherwise. Other examples of changes, substitutions, and alterations are ascertainable by one skilled in the art and could be made without departing from the scope disclosed herein.

Many modifications and other embodiments of the disclosure set forth herein will come to mind to one skilled in the art to which these embodiments pertain having the benefit of teachings presented in the foregoing descriptions and the associated figures. Although the figures only show certain components of the apparatuses and systems described herein, various other components may be used in conjunction with the components and structures disclosed herein. Therefore, it is to be understood that the disclosure is not to be limited to the specific embodiments disclosed and that modifications and other embodiments are intended to be included within the scope of the appended claims. For example, the various elements or components may be combined, rearranged, or integrated in another system or certain features may be omitted or not implemented. Moreover, the steps in any method described above may not necessarily occur in the order depicted in the accompanying drawings, and in some cases one or more of the steps depicted may occur substantially simultaneously, or additional steps may be involved. Although specific terms are employed herein, they are used in a generic and descriptive sense only and not for purposes of limitation.

What is claimed is:

1. A digital display device comprising:
a rigid housing defining an internal chamber and an opening to a battery compartment, the battery compartment separated from the internal chamber and adapted to receive a battery in a position with a longitudinal axis of the battery being substantially parallel to the opening to the battery compartment;
a compressible layer over at least a portion of the rigid housing, the compressible layer defining an opening that is coterminous with the opening to the battery compartment; and,
a rigid cover having an interior side and an opposing exterior side and being selectively attachable to the rigid housing such that, when the rigid cover is selectively attached to the rigid housing, at least a portion of the compressible layer is sandwiched between the rigid cover and the rigid housing and at least a portion of the rigid cover at least partly compresses a corresponding portion of the compressible layer.

2. The digital display device of claim 1, wherein the rigid cover comprises at least two opposing jaws projecting from the interior side and adapted to hold the battery therebetween in a position such that the longitudinal axis of the battery is substantially parallel to the interior side for insertion into the battery compartment when the rigid cover is selectively attached to the rigid housing.

3. The digital display device of claim 2, wherein the at least two opposing jaws each have curved medial edges adapted to contact an exterior wall of the battery to hold the battery.

4. The digital display device of claim 2, wherein the at least two opposing jaws comprise two jaws on a first side of a midline of the rigid cover and one jaw on a second, opposing side of the midline of the rigid cover.

5. The digital display device of claim 1, wherein the rigid cover defines a fastener hole for inserting a fastener to secure the rigid cover to the rigid housing; and wherein the rigid cover further comprises a ridge protruding from the interior side and surrounding the fastener hole such that, when the rigid cover is selectively attached to the rigid housing, the ridge at least partly compresses a corresponding portion of the compressible layer.

6. The digital display device of claim 1, wherein the rigid cover comprises a pull ring pivotably attached to the exterior side of the rigid cover.

7. A self-contained breathing apparatus comprising:
an air tank;
a face mask connected via tubing to the air tank; and,
a digital display device for displaying an air pressure reading of the air tank, the digital display device comprising:
a rigid housing defining an internal chamber and an opening to a battery compartment, the battery compartment separated from the internal chamber and adapted to receive a battery in a position with a longitudinal axis of the battery being substantially parallel to the opening to the battery compartment;
a compressible layer over at least a portion of the rigid housing, the compressible layer defining an opening that is coterminous with the opening to the battery compartment; and,
a rigid cover having an interior side and an opposing exterior side and being selectively attachable to the rigid housing such that, when the rigid cover is selectively attached to the rigid housing, at least a portion of the compressible layer is sandwiched between the rigid cover and the rigid housing and at least a portion of the rigid cover at least partly compresses a corresponding portion of the compressible layer.

8. The self-contained breathing apparatus of claim 7, wherein the rigid cover comprises at least two opposing jaws projecting from the interior side and adapted to hold the battery therebetween in a position such that the longitudinal axis of the battery is substantially parallel to the interior side for insertion into the battery compartment when the rigid cover is selectively attached to the rigid housing; and wherein the at least two opposing jaws each have curved medial edges adapted to contact an exterior wall of the battery to hold the battery.

9. The self-contained breathing apparatus of claim 8, wherein the at least two opposing jaws comprise two jaws on a first side of a midline of the rigid cover and one jaw on a second, opposing side of the midline of the rigid cover.

10. The self-contained breathing apparatus of claim 7, wherein the rigid cover defines a fastener hole for inserting a fastener to secure the rigid cover to the rigid housing; and wherein the rigid cover further comprises a ridge protruding from the interior side and surrounding the fastener hole such that, when the rigid cover is selectively attached to the rigid housing, the ridge at least partly compresses a corresponding portion of the compressible layer.
